(19) United States
(12) Patent Application Publication
(10) Pub. No.: US 2015/0240163 A1
(43) Pub. Date: Aug. 27, 2015

(54) FIRE CORE COMPOSITIONS AND METHODS

(71) Applicant: MACH IV, LLC, Dallas, TX (US)

(72) Inventor: Charles D. Welker, Dallas, TX (US)

(21) Appl. No.: 14/630,578

(22) Filed: Feb. 24, 2015

Related U.S. Application Data
(60) Provisional application No. 61/944,317, filed on Feb. 25, 2014.

(51) Int. Cl. C09K 21/02; C04B 7/02; C04B 11/00; C04B 7/32

(52) U.S. Cl. CPC C09K 21/02; C04B 7/32; C04B 7/323; C04B 7/02; C04B 11/00

(57) ABSTRACT

The present invention describes an improved building material composition, useful for example as a fire door core and the improved methods of making this composition. More particularly, the building material of the present invention is prepared from hollow microspheres and an aqueous mixture of a cementitious composition containing at least one of the following: a hydraulic cement, an accelerant, or a refractory binder, which composition can be molded and shaped into a fire door core.

### CROSS-REFERENCE TO RELATED APPLICATIONS

This application claims the benefit of U.S. provisional application number 61/944,317, filed on Feb. 25, 2014, the contents of which are incorporated by reference in their entirety herein.

### FIELD OF THE INVENTION

The present invention relates to compositions and methods designed to slow the progress of a fire in a dwelling or commercial building. More particularly, the invention relates to a core compositions and methods of making same for utilization in a fire proof doors, walls, ceilings and floors.

### BACKGROUND OF THE INVENTION

The principal means of passive fire protection in structures is by completely enclosing areas with fire barriers. Fire barriers may include fire doors, walls, ceilings, and floors. Fire barriers play an integral role in managing a fire by interrupting the spread of smoke, other toxic gases, and the fire itself from one fire zone into another. Often, the potentially weakest points in a fire barrier are the doors to an area because the doors may not be as fire retardant as the walls and ceilings of an enclosure.

Fire doors are generally made for the purpose of stopping or delaying the transfer of thermal energy (i.e., heat), from one side of the door to the other side. Current fire-resistant doors generally contain a fire-resistant core usually encased in a door-shaped shell, wherein the shell is made from various materials generally known to those of ordinary skill in the art. The core is customarily bonded or glued to both inside surfaces of the shell.

Fire doors, as used in residential, commercial, and industrial applications, typically are employed in conjunction with fire walls to provide fire protection between different zones of a structure, and particularly to isolate high fire risk areas of a building from the remainder of the structure, such as the garage of a dwelling from its living quarters. Fire doors usually are not capable of indefinitely withstanding the high temperature conditions of a fire but, rather, are designed to maintain the integrity of the fire wall for a limited time to permit the occupants of a building to escape and to delay the spread of fire and smoke or gas until fire control equipment can be brought to the scene.

Various tests have been designed for fire doors and are based on factors, such as the time that a given door would withstand a certain temperature while maintaining its integrity, and hose stream tests which involve the door's ability to withstand the forces of a high pressure water stream.

A number of standard tests of fire door effectiveness have been developed for use in the building industry. These are published, for example, in the Uniform Building Code (UBC), the International Building Code (IBC), and by the National Fire Protection Association (NFPA), Underwriter's Laboratories (UL), and the American Society for Testing and Materials (ASTM), among others. Various agencies test fire doors using these standard tests, and assign ratings to fire doors that indicate theft effectiveness at slowing the progress of a fire. Door testing agencies include Intertek Testing Services (USA), Underwriter's Laboratories (USA), Omega Point Laboratories (USA), Chiltern International Fire, Ltd. (UK), and Warrington Fire Research (UK), among others. Ratings of fire doors are generally provided in minutes, and typically vary from 20 minutes to 120 minutes.

For instance, the American Society for Testing Materials (ASTM) has devised tests to establish fire door standards and these standards are incorporated into building codes and architectural specifications. One such standard, ASTM Method E 152 (ASTM E152, CAN 4-S104), requires a door to maintain its integrity for period ranging up to 1.5 hours while withstanding progressively higher temperatures and erosive effects of a high pressure stream of water from a fire hose at the conclusion of the heat (fire) exposure. A critical requirement of this test is that on being subjected to a flame at 1850° C. the door must not increase in temperature on average to over 250° C. after a period of 60 minutes.

Considerations in fire door design, in addition to retarding the advance of fire, include the cost of raw materials and the cost of fabrication. Furthermore, the weight of the door is important, from the standpoint of multiple aspects including ease of handling, weight placed on hinges, especially over time and cost of transportation. Since fire doors must pass the above-described water stream test as well as have the requisite strength to withstand normal use and abuse, the strength of the door is also a significant factor, often compromised by the core composition having high affinity to water causing the core to easily deform (warp) due to the heat exposure.

Fire-resistant doors have been made using a variety of constructions and utilizing a number of different materials, including wood, metal, and mineral materials. Early forms of fire doors simply comprised wooden cores faced with metal sheeting. Although wood of ample thickness is an effective fire and heat retardant, doors of such construction tend to be heavy and are expensive to fabricate and transport.

Mineral fibers have also been employed in the manufacture of fire doors. The core of a commercial metal fire door principally comprises a composition including mineral fibers and a binder. Such doors suffer, however, from a lack of strength, and handling the friable cores results in the production of irritating dust particles during the manufacturing process.

Current fire-resistant cores are generally constructed using such materials as perlite (which functions as an inorganic filler), gypsum (which functions as the persistent material), cement (which functions as a further resistant material and counteracts shrinkage of the core), a solution of polyvinyl alcohol and water (which also acts as a binder and increases the viscosity of the mixture of ingredients while also hydrating the gypsum) and fiberglass (which functions as a reinforcing material). See for example U.S. Pat. No. 4,159,302, the disclosure of which is incorporated herein by reference.

It has also been proposed to make fire doors wherein the core comprises particles of expanded perlite, which are bound together by the use of various hydraulic binders including gypsum, cement, and inorganic adhesive material. In order to provide sufficient strength, particularly to withstand handling of the core during manufacture, the core typically is compressed to compact the mixture to a relatively high density, resulting in a heavy door.

Other fire doors have included vermiculite, mineral core dust and gypsum as a core material. However, in order to produce sufficient fire resistance, the thickness required of the wallboard is such as to result in an excessively heavy door. Furthermore, internal structural members such as rails or mullions have been found necessary to support and strengthen wallboard panels. The need for such reinforcing elements increases the cost of materials and assembly of such doors. In addition to the above-mentioned considerations, fire doors must, in order to be commercially acceptable, also have other properties that are related to the manufacture, installation and service of the fire door.

Fire door cores that contain a significant proportion of vermiculite, mineral core dust and gypsum may lose their fire resistant capabilities in the course of a fire. It is, however, noted that the gypsum cement may be utilized as a fire-resistant material. As is well known, all three above-mentioned constituents exhibit high water absorption rate and require larger quantity of water to create a blend. Consequently, when contacted with heat during a fire, cause deformation of the core (warping) as the water in the blended mixture moves toward the high temperature. This, in turn, may cause the core to lose strength and integrity, especially when thereafter exposed to water, such as a high pressure stream of water from a hose. Furthermore, gypsum calcines when contacted with sustained heat to cause the core to lose strength and integrity. Thus, the fire resistance and structural integrity of such a door core is degraded. Furthermore, the high water absorption rates in current fire-resistant door cores containing vermiculate, mineral core dust and gypsum increase both their size and density.

US. Pat. No. 6,340,389 describes a fire door cores made from expanded perlite, a fireproof binder such as an alkali metal silicate, fire clay or vermiculite, and optionally one or more viscosity-enhancing components, fiberglass, or both. The fire door core is made using a semi-continuous batch press method wherein water, the expanded perlite, the fireproof binder, fire clay or vermiculite are mixed; and the wet mixture is compressed in a mold, and the compressed mixture dried.

There exists a commercial need for building materials suitable for use as a door core that not only is fire-resistant, but also closer to being fire-proof. In order to meet this commercial need, the door core must maintain its strength and integrity after being exposed to heat. Additionally, in order to be commercially viable (relatively cheaper to manufacture and easier to handle) the door core must be easily manufactured using techniques well-known in the art, and have improved hose stream resistance after heat exposure. The present invention fulfills these commercial needs.

### SUMMARY OF THE INVENTION

The present invention is directed to a building material composition useful as a fire door core. Building material compositions (e.g., fire door cores) of the present invention can meet or exceed the fire-resistant capabilities of current fire door cores. The building material composition (e.g., fire door core) of the present invention is substantially free of vermiculite, mineral core dust, molding plaster (gypsum), all having high water affinity, which lowers the fire-resistance and other performance requirements of the fire-proof product.

The building material composition (e.g., fire door core) of the present invention is made up of two main components. The first component is hollow microspheres, having both structural and heat-insulating properties, which are low-density, non-combustible additive of low-thermal conductivity capable of withstanding injection molding and extrusion pressures of up to approximately 30,000 PSI. The hollow microspheres can be made from a variety of materials capable of withstanding the forces that occur in concrete preparation, pouring, and finishing processes. In one embodiment, the hollow microspheres have a crush strength of about 1,000 PSI or higher or of about 2,500 PSI or higher or of about 5,000 PSI or higher or of about 10,000 PSI or higher or of about 15,000 PSI or higher. In another embodiment, the hollow microspheres have a density of less than about 1 gram per cubic centimeter (g/cm³) or less than about 0.9 g/cm³ or less than about 0.8 g/cm³ or less than about 0.7 g/cm³ or less than about 0.6 g/cm³ or less than about 0.5 g/cm³. Non-limiting examples of materials include glass, ceramic, metals, plastic, and composites. In one embodiment, the hollow microspheres can be made from glass. Non-limiting examples of commercially available hollow microspheres include the 3M™ glass bubbles series (e.g. iM30K, iM16K, S60HS, S60, K42HS, K46, S38XHS and S38HS (3M® St. Paul, Minn.)), the Poraver® Expanded glass series (Dennert Poraver GmbH, Schlusselfeld, Bavaria) and Expancel microspheres series (Akzo Nobel, Sweden).

The second component is a cementitious composition. The cementitious composition may include a cement, an accelerant, or a binder. The cementitious composition may include a refractory cement, an accelerant, or a binder. The cementitious composition may include a hydraulic cement, an accelerant or a binder. Generally, the cement may be those that meet the industry standards such as (but not limited to) standards set by American Society for Testing and Materials (ASTM), American Association of State Highway and Transportation (AASHTO), British Standard, or French Norm. Non-limiting example of cement include calcium aluminate cement, CIMENT FONDU® cement (Kerneos Corp., France), Portland cement, refractory cement, magnesium based cement, gypsum cement, or other cement with mixtures of silicates, oxides (e.g. magnesium, belite, alite, celite, or brownmillerite), perlite, bentonite clay, fireclay, or mixtures thereof. The accelerant may be an alkali metal halide, alkali metal nitrite, an alkali metal nitrate, an alkali metal formate, and alkali metal thiocynate, a calcium chloride, a non-calcium chloride, a calcium carbonate, a calcium hydroxide, triethanol amine, sodium thiocyanate, sodium nitrate, calcium formate, calcium nitrate, calcium nitrite, lithium hydroxide monohydrate, lithium sulfate monohydrate, lithium carbonate, potash, calcium sulfoaluminate cement, or RAPID SET® cement (CTS Cement, Cypress, Calif.). The binder may be type C fly ash, type F fly ash, pozzolanic materials, slag, silica fume, metakaolin, aluminosilicate powders, calcium sulfate, magnesium phosphate, lime, magnesium oxides, geopolymers, and gypsum, starches, dextrin gums, polyvinyl alcohol, polyvinyl acetate, polymers of vinyl acetate and ethylene, polymers of styrene and butadiene, acrylic resins, or rice hulls.

In one embodiment the building material composition (e.g., fire door core) comprises hollow microspheres in an amount of up to about 50% by dry weight of the composition or in an amount of up to about 30% by dry weight of the composition of in an amount between about 4% to about 23% by dry weight of the composition. If present, the hydraulic cement can be from about 20% to about 85% or from about 30% to about 80% or from about 40% to about 60% of the dry weight of the composition. If present, the accelerant can be from about 2% to about 10% or from about 2.5% to about 9% or from about 3% to about 8% of the dry weight of the composition. If present, the binder can be from about 4% to about 80% or from about 6% to about 60% or from about 20% to about 55% of the dry weight of the composition.

In another embodiment, the building material/fire door core composition can include fibrous reinforcement such as glass fibers, steel fibers, sisal fibers, graphite, synthetic fibers, polyolefin fibers, polyethylene fibers, polypropylene fibers, rayon fibers, and polyacrylonitrile fibers. The fibrous reinforcements may be present in the amount within the range of about 1% to about 6.0% or from about 1.5% to about 5% or from about 2% to about 4.5% by weight of the dry mixture of the constituents.

In another embodiment, the building material/fire door core composition can include a dispersant such as water soluble polymers, superplasticizers, sodium pentahydyoxycaproate based, polycarboxylate based, melamine sulfonic acid based, naphthalenesuflonic acid based, lingosulfonate based, or SC-9 (Fritz Industries, Mesquite, Tex.). The dispersant may be present in the amount within the range of about 0.75% to about 4.5% or from about 1.5% to about 4.25% or from about 2.5% to about 4.0% by weight of the dry mixture of the constituents.

In another embodiment, the building material/fire door core composition can include a suspension agent such as bentonite based, cellulose based, gum based, lingosulfonate based, palygorskite based, polyvinyl alcohol based, polyvinyl pyrrolidone based, or MS510 (Miracon Technologies, Richardson, Tex.).). The suspension agent may be present in the amount within the range of about 0.01% to about 0.6% or from about 0.05% to about 0.4% or from about 0.1% to about 0.3% by weight of the dry mixture of the constituents.

In another embodiment, the building material/fire door core may also contain an air entraining agent (admixture) such as wood resins, animal or vegetable fats, wetting agents, water soluble soaps of certain acids, Eucon air entraining admixtures (Euclid Chemical, Cleveland, Ohio), DAREX ® air entraining admixture (WR Grace & Co, Cambridge, Mass.), AIRALOM 3000 (WR Grace & Co.), DARAVAIR (WR Grace & Co.), TERAPAVE AEA (WR Grace & Co.), Air Plus (Fritz-Pak Corporation, Mesquite, Tex.), MB AE-90 (Master Builders (BASF), Florham Park, N.J.), TOUGH AIR ® admixture (Miracon Technologies, Richardson, Tex.), MasterAir (BASF Construction Chemicals, Cleveland, Ohio), MasterCell (BASF), CreteFoam CMX (Richway Industries, LTD, Janesville, Iowa), Sika (Sika Corporation, Lyndhurst, N.J.), Air 260 (Chryso, Rockwell, Tex.), Con Air (Premiere Admixtures, Pioneer, Ohio), RSA-10 (Russ Tech Admixtures, Jeffersontown, Ky.), RVR-15 (Russ Tech Admixtures), and Lightcrete Powder (Sika Corporation). The air entraining agent may be added within the range of about 0.1 to about 3% or from about 0.2% to about 2% or from about 0.3% to about 1% by weight of the dry mixture of the constituents.

In yet another embodiment, the building material/fire door core can include a diatomaceous earth. The diatomaceous earth may be present in the amount of up to 20% or within the range of about 2% to about 18% or from about 4% to about 15% or from about 6% to about 12% by weight of the building material composition, e.g., the fire door core.

In one embodiment of the present invention the building material composition (e.g., fire door core) comprises as an essential constituent, hollow microspheres. The hollow microspheres can be made from glass, ceramics, metals, plastics, or composites. A second, essential constituent of the building material/fire door composition is a cementitious composition. The cementitious composition can be made up of a cement component such as hydraulic cement, refractory cement, calcium aluminate cement, CIMENT FONDU cement, gypsum cement, magnesium based cement, Portland cement, cements with a mixture of silicates, oxides, perlite, clay, bentonite clay, or fire clay, and combinations thereof, an accelerant such as alkali metal halides, alkali metal nitrites, alkali metal nitrates, alkali metal formates, alkali metal thiocyanates, calcium chloride, non-calcium chloride, calcium carbonate, calcium hydroxide, triethanol amine, sodium thiocyanate, sodium nitrate, calcium formate, calcium nitrate, calcium nitrite, lithium hydroxide monohydrate, lithium sulfate monohydrate, lithium carbonate, potash, calcium sulfoaluminate cement, or RAPID SET cement, and a binder such as type C fly ash, type F fly ash, pozzolanic materials, slag, silica fume, metakaolin, aluminosilicate powders, calcium sulfate, magnesium phosphate, lime, magnesium oxides, geopolymers, and gypsum, starches, dextrin gums, polyvinyl alcohol, polyvinyl acetate, polymers of vinyl acetate and ethylene, polymers of styrene and butadiene, acrylic resins, or rice hulls . Upon being mixed with water in an amount within the range of about 18% to about 29% or from about 22% to about 28% or from about 24% to about 27% by weight of the dry mixture of the constituents, the resulting moist composition exhibits a suitable setting time for manufacturing door cores. The moist building material composition, can be molded, shaped and cured into a fire door core.

In one embodiment, the building material/fire door core comprises hollow microspheres from about 4% to about 23% by weight of the dry mixture of the constituents with the balance made up by a cementitious composition that includes at least one of the following: cement, accelerant, or a binder. The cement component may be present in the amount within the range of about 20% to about 85% or from about 30% to about 80% or from about 40% to about 60% by weight of the dry mixture of the constituents. In another embodiment, the accelerant, may be present in the amount within the range of about 2% to about 10% or from about 2.5% to about 9% or from about 3% to about 8% by weight of the dry mixture of the constituents. In another embodiment, the binder may be present in the amount within the range of about 4% to 80% or from about 6% to about 60.0% or from about 20% to about 55%, by weight of the dry mixture of the constituents. Further, the building material/fire door core may also contain a fibrous reinforcement which may be present in the amount within the range of about 1% to about 6% or from about 1.5% to about 5% or from about 2% to about 4.5% by weight of the dry mixture of the constituents. The building material/fire door core may also contain a cement dispersant which may be present in the amount within the range of about 0.75% to about 4.5% or from about 1.5% to about 4.25% or from about 2.5% to about 4% by weight of the dry mixture of the constituents. In one embodiment, the hydraulic cement has a dispersant pre-blended into the cement. According to yet another embodiment of the present invention, the building material/fire door core may also contain a suspension agent which may be present in the amount within the range of about 0.01% to about 0.6% or from about 0.05% to about 0.4% or from about 0.1% to about 0.3% by weight of the dry mixture of the constituents. In yet another embodiment, the building material/fire door core may also contain an air entrainment agent/admixture which may be present in the amount within the rage of about 0.1% to about 3.0% or from about 0.2% to about 2.0% or from about 0.3% to about 1% by weight of the dry mixture of the constituents.

In one embodiment, the building material/fire door core composition includes hollow microspheres, a hydraulic cement, an accelerant, and a binder. In one embodiment, the building material/fire door core composition includes hollow microspheres, a hydraulic cement, an accelerant, a binder, and a dispersant. In one embodiment, the building material/fire door core composition includes hollow microspheres, a hydraulic cement, an accelerant, a binder, and a suspension agent. In another embodiment, the building material/fire door core composition includes hollow microspheres, a hydraulic cement, an accelerant, a binder, and an air entrainment agent/admixture. In one embodiment, the building material/fire door core composition includes hollow microspheres, a hydraulic cement, an accelerant, a binder, and fibrous reinforcement.

In one embodiment, the building material/fire door core composition includes hollow microspheres, a hydraulic cement, an accelerant, a binder, fiber reinforcements, and a dispersant. In one embodiment, the building material/fire door core composition includes hollow microspheres, a hydraulic cement, an accelerant, a binder, a fiber reinforcements, and a suspension agent.. In one embodiment, the building material/fire door core composition includes hollow microspheres, a hydraulic cement, an accelerant, a binder, a fiber reinforcements, and air entrainment agent/admixture. In another embodiment, the building material/fire door core composition includes hollow microspheres, a hydraulic cement, an accelerant, a binder, a dispersant, a suspension agent, and fiber reinforcements. In another embodiment, the building material/fire door core composition includes hollow microspheres, a hydraulic cement, an accelerant, a binder, a dispersant, an air entrainment agent/admixture, and fiber reinforcements. In another embodiment, the building material/fire door core composition includes hollow microspheres, a hydraulic cement, an accelerant, a binder, a suspension agent, an air entrainment agent/admixture, and fiber reinforcements. In another embodiment, the building material/fire door core composition includes hollow microspheres, a hydraulic cement, an accelerant, a binder, a dispersant, a suspension agent, an air entrainment agent/admixture, and fiber reinforcements. In another embodiment, the building material/fire door core composition includes hollow microspheres, a hydraulic cement, an accelerant, a binder, a dispersant, a suspension agent, an air entrainment agent/admixture, diatomaceous earth, and fiber reinforcements.

In one embodiment, the building material/fire door core composition includes hollow microspheres, a refractory cement, an accelerant, and a binder. In one embodiment, the building material/fire door core composition includes hollow microspheres, a refractory cement, an accelerant, a binder, and a dispersant. In one embodiment, the building material/fire door core composition includes hollow microspheres, a refractory cement, an accelerant, a binder, and a suspension agent. In another embodiment, the building material/fire door core composition includes hollow microspheres, a refractory cement, an accelerant, a binder, and an air entrainment agent/admixture. In one embodiment, the building material/fire door core composition includes hollow microspheres, a refractory cement, an accelerant, a binder, and fibrous reinforcement.

In one embodiment, the building material/fire door core composition includes hollow microspheres, a refractory cement, an accelerant, a binder, fiber reinforcements, and a dispersant. In one embodiment, the building material/fire door core composition includes hollow microspheres, a refractory cement, an accelerant, a binder, a fiber reinforcements, and a suspension agent.. In one embodiment, the building material/fire door core composition includes hollow microspheres, a refractory cement, an accelerant, a binder, a fiber reinforcements, and air entrainment agent/admixture. In another embodiment, the building material/fire door core composition includes hollow microspheres, a refractory cement, an accelerant, a binder, a dispersant, a suspension agent, and fiber reinforcements. In another embodiment, the building material/fire door core composition includes hollow microspheres, a refractory cement, an accelerant, a binder, a dispersant, an air entrainment agent/admixture, and fiber reinforcements. In another embodiment, the building material/fire door core composition includes hollow microspheres, a refractory cement, an accelerant, a binder, a suspension agent, an air entrainment agent/admixture, and fiber reinforcements. In another embodiment, the building material/fire door core composition includes hollow microspheres, a refractory cement, an accelerant, a binder, a dispersant, a suspension agent, an air entrainment agent/admixture, and fiber reinforcements. In another embodiment, the building material/fire door core composition includes hollow microspheres, a refractory cement, an accelerant, a binder, a dispersant, a suspension agent, an air entrainment agent/admixture, diatomaceous earth, and fiber reinforcements.

In one embodiment, the building material/fire door core composition includes hollow glass microspheres, a hydraulic cement, an accelerant, and a binder. In one embodiment, the building material/fire door core composition includes hollow glass microspheres, a hydraulic cement, an accelerant, a binder, and a dispersant. In one embodiment, the building material/fire door core composition includes hollow glass microspheres, a hydraulic cement, an accelerant, a binder, and a suspension agent. In another embodiment, the building material/fire door core composition includes hollow glass microspheres, a hydraulic cement, an accelerant, a binder, and an air entrainment agent/admixture. In one embodiment, the building material/fire door core composition includes hollow glass microspheres, a hydraulic cement, an accelerant, a binder, and fibrous reinforcement.

In one embodiment, the building material/fire door core composition includes hollow glass microspheres, a hydraulic cement, an accelerant, a binder, fiber reinforcements, and a dispersant. In one embodiment, the building material/fire door core composition includes hollow glass microspheres, a hydraulic cement, an accelerant, a binder, a fiber reinforcements, and a suspension agent.. In one embodiment, the building material/fire door core composition includes hollow glass microspheres, a hydraulic cement, an accelerant, a binder, a fiber reinforcements, and air entrainment agent/admixture. In another embodiment, the building material/fire door core composition includes hollow glass microspheres, a hydraulic cement, an accelerant, a binder, a dispersant, a suspension agent, and fiber reinforcements. In another embodiment, the building material/fire door core composition includes hollow glass microspheres, a hydraulic cement, an accelerant, a binder, a dispersant, an air entrainment agent/admixture, and fiber reinforcements. In another embodiment, the building material/fire door core composition includes hollow glass microspheres, a hydraulic cement, an accelerant, a binder, a suspension agent, an air entrainment agent/admixture, and fiber reinforcements. In another embodiment, the building material/fire door core composition includes hollow glass microspheres, a hydraulic cement, an accelerant, a binder, a dispersant, a suspension agent, an air entrainment agent/admixture, and fiber reinforcements. In another embodiment, the building material/fire door core composition includes hollow glass microspheres, a hydraulic cement, an accelerant, a binder, a dispersant, a suspension agent, an air entrainment agent/admixture, diatomaceous earth, and fiber reinforcements.

In another embodiment, the building material/fire door core composition includes hollow glass microspheres, a calcium aluminate cement, an accelerant, and a binder, and optionally a dispersant, a suspension agent, an air entrainment agent/admixture, or fibrous reinforcement. In another embodiment, the building material/fire door core composition includes hollow glass microspheres, a calcium aluminate cement, calcium sulfoaluminate cement, and a binder, and optionally a dispersant, a suspension agent, an air entrainment agent/admixture, or fibrous reinforcement. In another embodiment, the building material/fire door core composition includes hollow glass microspheres, a calcium aluminate cement, calcium sulfoaluminate cement, and fly ash, and optionally a dispersant, a suspension agent, an air entrainment agent/admixture, or fibrous reinforcement. In another embodiment, the building material/fire door core composition includes hollow glass microspheres, a calcium aluminate cement, calcium sulfoaluminate cement, fly ash, fibrous reinforcement, a suspension agent, and a dispersant. In another embodiment, the building material/fire door core composition includes hollow glass microspheres, a calcium aluminate cement, calcium sulfoaluminate cement, fly ash, fibrous reinforcement, a suspension agent, a dispersant, and an air entrainment agent/admixture.

In another embodiment, the building material/fire door core composition includes hollow glass microspheres, Portland cement, an accelerant, and a binder, and optionally a dispersant, a suspension agent, an air entrainment agent/admixture, or fibrous reinforcement. In another embodiment, the building material/fire door core composition includes hollow glass microspheres, Portland cement, calcium sulfoaluminate cement, and a binder, and optionally a dispersant, a suspension agent, an air entrainment agent/admixture, or fibrous reinforcement. In another embodiment, the building material/fire door core composition includes hollow glass microspheres, Portland cement, calcium chloride, and a binder, and optionally a dispersant, a suspension agent, an air entrainment agent/admixture, or fibrous reinforcement. In another embodiment, the building material/fire door core composition includes hollow glass microspheres, Portland cement, calcium sulfoaluminate cement, and fly ash, and optionally a dispersant, a suspension agent, an air entrainment agent/admixture, or fibrous reinforcement. In another embodiment, the building material/fire door core composition includes hollow glass microspheres, Portland cement, calcium chloride, and fly ash, and optionally a dispersant, a suspension agent, an air entrainment agent/admixture, or fibrous reinforcement. In another embodiment, the building material/fire door core composition includes hollow glass microspheres, Portland cement, calcium sulfoaluminate cement, fly ash, fibrous reinforcement, a suspension agent, and a dispersant. In another embodiment, the building material/fire door core composition includes hollow glass microspheres, Portland cement, calcium sulfoaluminate cement, fly ash, fibrous reinforcement, a suspension agent, a dispersant, and an air entrainment agent/admixture. In another embodiment, the building material/fire door core composition includes hollow glass microspheres, Portland, calcium chloride, fly ash, fibrous reinforcement, a suspension agent, and a dispersant. In another embodiment, the building material/fire door core composition includes hollow glass microspheres, Portland cement, calcium chloride, fly ash, fibrous reinforcement, a suspension agent, a dispersant, and an air entrainment agent/admixture.

In another embodiment, the building material/fire door core composition includes hollow glass microspheres, gypsum cement, an accelerant, and a binder, and optionally a dispersant, a suspension agent, an air entrainment agent/admixture, or fibrous reinforcement. In another embodiment, the building material/fire door core composition includes hollow glass microspheres, gypsum cement, potash, and a binder, and optionally a dispersant, a suspension agent, an air entrainment agent/admixture, or fibrous reinforcement. In another embodiment, the building material/fire door core composition includes hollow glass microspheres, gypsum cement, potash, and fly ash, and optionally a dispersant, a suspension agent, an air entrainment agent/admixture, or fibrous reinforcement. In another embodiment, the building material/fire door core composition includes hollow glass microspheres, gypsum cement, potash, fly ash, fibrous reinforcement, a suspension agent, and a dispersant. In another embodiment, the building material/fire door core composition includes hollow glass microspheres, gypsum cement, potash, fly ash, fibrous reinforcement, a suspension agent, a dispersant, and an air entrainment agent/admixture.

The fire door core can be made by mixing the hollow microspheres, the above described cementitious composition and other optional additives which may also be used, such as dispersants, suspension agents, air entrainment agents/admixtures, or fibrous reinforcement, in the presence of an amount of water at least sufficient to provide a moist, (damp) mixture of the ingredients and sufficient to set the cementitious composition. Water usually can be added in an amount of between about 18% to about 29% by weight of the dry ingredients in the composition. The composition can then be molded into the desired shape, density and thickness for the building material/fire door core.

Any suitable apparatus or equipment used in building, construction, or concrete industry may be utilized to process the ingredients into the desired composition.

### DETAILED DESCRIPTION OF THE INVENTION

Throughout the description, the terms “one,” “a,” or “an” are used in this disclosure; they mean “at least one” or “one or more,” unless otherwise indicated

The terms “microsphere,” “microballoon,” “bubble,” and “bead,” are used interchangeably and refer to a roughly spherical shaped object that has a diameter in the micrometers.

The term “sphere,” “spherical,” or “microsphere” encompasses all three dimensional shapes that are roughly symmetrical. Non-limiting examples include shapes include spherical, cuboidal, pyramidal, cylindrical, multi-sided prisms and polyhedrons.

The building material composition, preferably in the form of a fire door core, of the present invention comprises as a critical component a hollow microspheres and as a second component a cementitious composition. Each component is described below.

### Hollow Microspheres

Hollow microspheres function as non-combustible fillers which impart light weight, relatively high strength, and fire retardant properties to building materials such as fire door cores. The microspheres may be made of any material that can withstand the building material manufacturing processes as well as provide fire retardant properties to the final product. Non-limiting examples of hollow microsphere materials include glass, ceramic, metals, plastics, and composites.

The hollow microspheres have a core and shell construction, where the core is hollow, and is filled with a gas either at atmospheric pressure or at reduced pressure. The hollow microspheres can be roughly symmetrical in shape. Non-limiting examples of shapes include spherical, cuboidal, pyramidal, cylindrical, multi-sided prisms, and polyhedrons.

In one embodiment, the aspect ratio of the short axis and long axis may be greater than about 0.70. In another embodiment, the aspect ration may be greater than about 0.75. In another embodiment, the aspect ration may be greater than about 0.80. In another embodiment, the aspect ration may be greater than about 0.85. In another embodiment, the aspect ration may be greater than about 0.90. In yet another embodiment, the aspect ration may be greater than 0.95.

The crush strength or collapse strength of the hollow microspheres generally refers to the maximum pressure the beads can withstand while remaining intact. The crush strength tends to depend on the material, the particle density, the particle size, and the wall or shell thickness. In general, smaller particle size and thicker walls tend to generate hollow microspheres with higher crush strengths when comparted to larger particles with thinner walls made from the same material. ASTM standards for testing the crush strength of various materials used to make hollow microsphere may be available. One such example is ASTM D-3102-78, which may be used to determine the crush strength of hollow glass microspheres. In one embodiment, the hollow microspheres have a crush strength of about 1,000 PSI or higher. In another embodiment, the hollow microspheres have a crush strength of about 2,500 PSI or higher. In another embodiment, the hollow microspheres have a crush strength of about 5,000 PSI or higher. In another embodiment, the hollow microspheres have a crush strength of about 10,000 PSI or higher. In yet another embodiment, the hollow microspheres have a crush strength of about 15,000 PSI or higher.

In one embodiment, the hollow microspheres have a density of less than about 1 gram per cubic centimeter (g/cm³). In another embodiment, the hollow microspheres have a density of less than about 0.9 g/cm³. In another embodiment, the hollow microspheres have a density of less than about 0.8 g/cm³. In yet another embodiment, the hollow microspheres have a density of less than about 0.7 g/cm³. In yet another embodiment, the hollow microspheres have a density of less than about 0.6 g/cm³. In yet another embodiment, the hollow microspheres have a density of less than about 0.5 g/cm³. The density of the hollow microspheres can be measured using a pycnometer (gas phase replacement type true density meter, such as AccuPyc II 1340 manufactured by Micromeritics).

In one embodiment, the hollow microspheres have a median diameter of less than about 200 micrometers (um). In another embodiment, the hollow microspheres have a median diameter of less than about 150 um. In another embodiment, the hollow microspheres have a median diameter of less than about 100 um. In another embodiment, the hollow microspheres have a median diameter of less than about 75 um. In another embodiment, the hollow microspheres have a median diameter of less than about 50 um. In another embodiment, the hollow microspheres have a median diameter of between about 10 um and about 200 um. In another embodiment, the hollow microspheres have a median diameter of between about 20 um and about 150 um. In another embodiment, the hollow microspheres have a median diameter of between about 30 um and about 100 um. In another embodiment, the hollow microspheres have a median diameter of between about 30 um and about 75 um.

In one embodiment, the amount of hollow microspheres can be up to about 5% by weight of the building material dry weight components. In one embodiment, the amount of hollow microspheres can be up to about 10% by weight of the building material dry weight components. In one embodiment, the amount of hollow microspheres can be up to about 20% by weight of the building material dry weight components. In one embodiment, the amount of hollow microspheres can be up to about 30% by weight of the building material dry weight components. In one embodiment, the amount of hollow microspheres can be up to about 40% by weight of the building material dry weight components. In one embodiment, the amount of hollow microspheres can be up to about 50% by weight of the building material dry weight components.

In one embodiment, the hollow microspheres can be made from glass. The hollow glass microspheres can have a shell that is primarily made of glass containing silicon dioxide (Si02) as a main component, with sodium oxide (Na02), magnesium oxide (MgO), calcium oxide (CaO), boron oxide (B205), phosphorus oxide (P205), and the like as accessory components. The size of the hollow glass microspheres can be measured using a commercial laser diffraction particle size analyzer (wet type, recirculating). Industrially, the hollow glass microspheres are usually manufactured by foaming glass

One non-limiting example of commercially available hollow glass microspheres (also called microballoons or glass beads) that can be used is 3M™ Glass Bubbles. Non-limiting grades of product that can be used include S6OHS (true density 0.6 g/cm3, 10 volume % isostatic collapse strength 18,000 PSI or higher (124 MPa or higher), iM3OK (true density 0.6 g/cm3, 10 volume % isostatic collapse strength 27,000 PSI or higher (186 MPa or higher)), S60 (true density 0.6 g/cm3, 10 volume % isostatic collapse strength 10,000 PSI or higher (69 MPa)), K42HS (true density 0.42 g/cm3, 10 volume % isostatic collapse strength 8000 PSI or higher (55 MPa or higher)), or the like.

Another non-limiting example of commercially available hollow glass microspheres that can be used include Shirasu balloons such as Winlight (MSB type, WB type, and SC type) provided by AXYZ Chemical Co., Ltd. However, Shirasu balloons generally have a broad size range of 5 to 500 um, and the true density also has large variation from 0.6 g/cm3 to 1.1 g/cm3. Furthermore, the 10 volume % isostatic collapse strength is generally approximately 8 to 10 MPa (measured when static water pressure is applied for 2 minutes). Therefore, the Shirasu balloons have a true density that is too high, the weight reducing effect is low, and the 10 volume % isostatic collapse strength is low, so 3M™ glass bubbles or Poraver® Expended Glass are preferably selected as the commercial product of the hollow glass microspheres that is used.

Other non-limiting commercially available microspheres may be obtained from Poraver® Expanded glass series (Dennert Poraver GmbH, Schlusselfeld, Bavaria) or Expancel microsphere series (Akzo Nobel, Sweden) may be also be utilized.

### Cementitious Composition

The cementitious composition can include at least one of the following components: a cement, an accelerant or a binder. In another embodiment, the cementitious composition includes at least two of the following components: a cement, an accelerant, or a binder. In yet another embodiment, the cementitious composition includes all three of the following: a cement, an accelerant, and a binder. In yet another embodiment, the cementitious composition may include at least two different cements, or at least two different accelerants, or at least two different binders. The cementitious composition is present in the door core in an amount of within the range of about 70.0% to about 98.0% or from about 80.0% to about 95.0% or from about 85.0% to about 93.0% by weight of the dry mixture of the constituents.

A. Cement

In the broad sense, cement is a binder, that is a substance that sets and hardens and can bind other materials together. Cement is generally categorized as non-hydraulic or hydraulic, depending upon the ability of the cement to be used in the presence of water. Non-hydraulic cement (e.g. slaked lime) will not set in wet conditions or underwater, rather it sets by reacting with carbon dioxide, such as the carbon dioxide present in the air. This reaction can take a significant amount of time because the partial pressure of carbon dioxide in the air is low. Hydraulic cement, on the other hand, sets in the presence of water. This reaction can be much faster since the water is dispersed throughout the cement. The cement may be present in the door core in an amount of within the range of about 50.0% to about 95% or from about 60.0% to about 90%, or from about 70% to about 90%, by weight of the dry mixture of the constituents.

In one embodiment, the cement used in the cementitious composition is a cement that meets the industry standards such as (but not limited to) standards set by American Society for Testing and Materials (ASTM), American Association of State Highway and Transportation (AASHTO), British Standard, or French Norm. In one embodiment, the cement used in the cementitious composition is a hydraulic cement. In another embodiment, the cement used in the cementitious composition is a refractory cement. In another embodiment, the cement used in the cementitious composition is a hydraulic refractory cement. In another embodiment, the cement includes a calcium aluminate component. In yet another embodiment, the cement is a fast setting or fast curing cement. Non-limiting examples of hydraulic cement include calcium aluminate cement, CIMENT FONDU® cement (Kerneos Corp., France), Portland cement, magnesium based cement, gypsum cement, and other cements with a mixture of silicates, oxides such as magnesium belite, alite, celite, or brownmillerite, clay, perlite, bentonite clay, fire clay, or combinations thereof.

Calcium aluminate cement is also referred to as a high alumina cement or CIMENT FONDU cement (Kerneos Corp., France) and has a high alumina content, usually at least about 20% by weight. The alumina is typically supplied by the inclusion of bauxite during the manufacture of the cement, and typically, calcium aluminate cement is formed by the sintering of clinkers of limestone and bauxite with small amounts of silica and other materials such as titanium oxide and iron oxide. For a further description of calcium aluminate cements, please refer to US. Pat. No. 4,033,782, the entire disclosure of which is incorporated herein by reference.

B. Accelerant

Accelerants in the broad sense are additives that decrease the setting time of cement, that is, the cement cures/hardens faster in the presence of the accelerant than without the additive. Non-limiting examples of the accelerant include alkali metal halides, alkali metal nitrites, alkali metal nitrates, alkali metal formates, alkali metal thiocyanates, calcium chloride, non-calcium chloride, calcium carbonate, calcium hydroxide, triethanol amine, sodium thiocyanate, sodium nitrate, calcium formate, calcium nitrate, calcium nitrite, lithium hydroxide monohydrate, lithium sulfate monohydrate, lithium carbonate, potash, calcium sulfoaluminate cement, and RAPID SET® products such as RAPID SET cement (sold by CTS Cement, Cypress, Calif.). The accelerant may be present in the door core in an amount of within the range of about 2% to about 10%or from about 2.5% to about 9% or about 3% to about 3% by weight of the dry mixture of the constituents.

In one embodiment, the accelerant can be a calcium sulfoaluminate cement such as RAPID SET cement sold by CTS Cement (Cypress, Calif.). In addition to having binding properties, calcium sulfoaluminate cement such as RAPID SET cement allows faster curing time in the mold. Other non-limiting examples of commercially available accelerants include BASF Calcium Chloride and FMC Lithium Hydroxide Monohydrate

According to one embodiment of the present invention, the hydraulic cement and the accelerant are present in the cementitious composition in a weight ratio of cement:accelerant (C:A) from about 5:1 to 15:1 or from about 7:1 to 10:1.

C. Binder

In the general sense, binders are fine, granular materials that form a paste when water is added to them. The paste hardens encapsulating other compounds mixed with the paste such as aggregates or other structural components. Non-limiting examples of binders include fly ash, pozzolanic materials, slag, silica fume, metakaolin, aluminosilicate powders, calcium sulfate, magnesium phosphate, lime, magnesium oxides, geopolymers, and gypsum, starches, dextrin gums, polyvinyl alcohol, polyvinyl acetate, polymers of vinyl acetate and ethylene, polymers of styrene and butadiene, acrylic resins, and rice hulls. Binders may be present in the door core in an amount within the range of about 4 to 80 percent by weight or within the range of about 4 to 50 percent by weight or within the range of about 8 to 40 percent by weight.

In one embodiment, the binder may be a refractory binder such as fly ash (class C or F). Refractory binders may be used to achieve desired textural and compressive strength and general handling characteristics. While desired strength characteristics can be achieved without the use of this binder and by using relatively much higher amounts of cement and an accelerant/binder, such option may become prohibitively expensive and, in addition, a higher content of cement increases the density of the product. Accordingly refractory binders may be used to reduce costs or decrease the density of the product

Fly ash produced from the burning of younger lignite or subbituminous coal, in addition to having pozzolanic properties, also has some self-cementing properties. In the presence of water, Class C fly ash will harden and gain strength over time. Class C fly ash generally contains more than 20% lime (CaO). Unlike Class F, self-cementing Class C fly ash does not require an activator (accelerant).

According to one embodiment of the present invention, the cementitious constituents of the present invention includes a binder and an accelerant , wherein the weight ratio of the binder:accelerant (B:A) is from about 5:1 to 15:1 or from about 8:1 to about 10:1.

The fly ash is typically a material which is dispersible or soluble in water. Commercially available fly ash for use in the composition of the present invention are available from the fly ash broker under the trade name Headwaters in the amount about 4.0 to about 80.0 % by weight of the dry components of the mixture. According to one embodiment of the present invention, no binder such as fly ash is included in the core mixture; however, to make the product economically feasible (cheaper), specific concentrations and amounts of the optional fly ash will be apparent to skilled practitioners who recognize that these parameters will vary depending on external preferences such as price and availability of the additional components on the various markets, and that the described embodiments do not limit the scope of the claimed invention.

### Optional Ingredients

Additional ingredients also may be included in the fire door construction to improve the physical, chemical, or performance characteristics of the final product. One example is the addition of a suspension agent. Suspension agents enhance the suspension of all materials in the composition, when materials have characteristic of widely differing specific gravities. This, in turn, enhances uniform density and matrix of materials and, consequently, more uniform performance properties, including strength. Non-limiting examples of suspension agents include bentonite based, cellulose based, gum based, lingosulfonate based, MS510 (sold by Miracon Technologies, Richardson, Tex.), and palygorskite based (Mg/AI phyllosilicate, general formula (Mg, Al)2Si4O10(OH).4(h2), commercially available as ACTI-GEL® 208 admixture, sold by Active Minerals International, Sparks, Md.). If present, the suspension agent is used in the amount in range from about 0.01 to about 1% or from about 0.01% to about 0.6% by weight of the dry ingredients in the composition.

Another optional ingredient is a dispersant. Dispersants are used to reduce the amount water while still keeping the same slum/flow properties of the concrete. Dispersants can reduce the apparent viscosity and improve the rheological properties of cement slurry. Use of dispersants can make the concrete stronger and more impervious to water penetration. Non-limiting examples of dispersants include plasticizers, sugar, sorbitol, water soluble polymers, superplasticizers, sodium pentahydyoxycaproate based, polycarboxylate based, melment, DAXDAD materials, melamine sulfonic acid based, naphthalenesuflonic acid based, lingosulfonate based, and SC-9 (sold by Fritz Industries, Mesquite, Tex.). If present, the dispersant is used in an amount from about 0.1% to about 10% or from about 0.5% to about 5% or from about 2% to about 4% by weight of the dry ingredients in the composition.

Yet another optional ingredients are fibrous reinforcements. Non-limiting examples of fibrous reinforcements include glass fibers, steel fibers, sisal fibers, graphite, and synthetic fibers such as, for example, polyolefin fibers, such as polyethylene fibers and polypropylene fibers, rayon fiber and polyacrylonitrile fiber. The fiber reinforcement may improve the material handling properties of the cured (dry) mixture, e.g., the cured (dry) door core mixture and especially the cured (dry) composite, e.g., the cured door core. Typically, when used, the amount of fiber reinforcement is up to about 6.0% or from about 1.0% to about 6.0% or from about 1.5% to about 5.0% or from about 2.0% to about 4.5% based on the weight of the dry ingredient used to form the building material composition, e.g., the fire door core.

Yet another optional ingredient is air entraining admixtures. Air entrainment is the intentional creation of tiny air bubbles in concrete. The air bubbles improve the workability and increases the slump of wet concrete. Once the concrete has hardened/cured, the air bubbles create areas for water to expand into when it freezes. Accordingly, air entrainment increases the durability of concrete, especially in climates subject to freeze-thaw. The specification for air entraining admixtures are covered by ASTM and AASHTO standards. Non-limiting examples of air entraining admixtures include those that meet ASTM (e.g. C260, C869, C869M, etc.) and AASHTO (e.g. M154, etc.) standards, wood resins, animal or vegetable fats, wetting agents, water soluble soaps of certain acids, Eucon air entraining admixtures (Euclid Chemical, Cleveland, Ohio), DAREX ® air entraining admixture (WR Grace & Co, Cambridge, Mass.), AIRALOM 3000 (WR Grace & Co.), DARAVAIR (WR Grace & Co.), TERAPAVE AEA (WR Grace & Co.), Air Plus (Fritz-Pak Corporation, Mesquite, Tex.), MB AE-90 (Master Builders (BASF), Florham Park, N.J.), TOUGH AIR® admixture (Miracon Technologies, Richardson, Tex.), MasterAir (BASF Construction Chemicals, Cleveland, Ohio), MasterCell (BASF), CreteFoam CMX (Richway Industries, LTD, Janesville, Iowa), Sika (Sika Corporation, Lyndhurst, N.J.), Air 260 (Chryso, Rockwell, Tex.), Con Air (Premiere Admixtures, Pioneer, Ohio), RSA-10 (Russ Tech Admixtures, Jeffersontown, Ky.), RVR-15 (Russ Tech Admixtures), and Lightcrete Powder (Sika Corporation). If present, the air entrainment admixture is used in an amount within the range of about 0.1% to about 3.0% or within the range of about 0.2% to about 2.0% or within the range of about 0.3% to about 1.0% by weight of the dry mixture of the constituents.

Yet another optional ingredient is diatomaceous earth. Diatomaceous earth is predominately silica and is composed of the skeletal remains of small prehistoric aquatic plants related to algae (diatoms). Particles of diatomaceous earth typically have intricate geometric forms. The irregular particle shapes are believed to improve the overall binding of the composition together and the resultant strength of the composition. Generally, the amount of such other optional components, such as the diatomaceous earth is less than about 20 weight percent of the building material composition, e.g., the fire door core. In the case of the diatomaceous earth in particular, when used the diatomaceous earth will generally be used in an amount of from about 2% to about 18% or from about 4% to about 15% or from about 6% to about 12% by weight of the building material composition, e.g., the fire door core. The amount of these optional components is preferably less than about 20% or even less than about 15% by weight.

Other components commonly used in fire door manufacturing are also contemplated as long as these other components do not adversely affect the advantageous properties, especially the fire resistant property, of the composition, e.g., the fire resistant property of the fire door core. Such ingredients include, but are not limited to, vermiculite, mineral core dust, and molding plaster.

Once set or cured, the cementitious composition disclosed herein imparts to the fire door core good water resistant properties and high compressive strength. Accordingly, the set cementitious composition aids greatly in maintaining the integrity of the fire door core when the door is exposed to the wetting and the pressure of a hose stream. In addition, the set cementitious composition functions as a shrink resistant material in the core when it is exposed to fire.

The building material composition, e.g., fire door core, of the present invention does not require vermiculite, mineral core dust, molding plaster containing gypsum as a main structural component and thereby avoids problems associated with current compositions used as door cores which rely primarily on components having high water requirements to effectuate proper blend. In one embodiment the building material composition of this invention is free from vermiculite, mineral core dust, molding plaster (gypsum) altogether. Current door cores that contain molding plaster (gypsum) cannot be considered fire-proof; at best, they can only be considered fire-resistant. Fire door cores, that contain mineral core dust and gypsum as a structural component, have high water requirements and when subjected to extended heating caused the door core to lose its strength and integrity by deforming its shape (water escapes causing deformation-warping of the door). In addition, when the door core thereafter is contacted by water, typically in the form of a high pressure stream of water from a hose, the integrity of the door is compromised because the integrity of the entire construction is already compromised and easy to be destroyed. The fire door core of the present invention is expected to meet or exceed the capabilities of current fire-resistant cores made with the vermiculite, mineral core dust and molding plaster (gypsum) fire tests for residential and non-residential use. The fire door core of the present invention also is expected to exceed the capabilities of fire-resistant door cores containing mineral dust and gypsum in maintaining strength and integrity following prolonged heat, even when exposed to water.

Although in some embodiments the material core composition is vermiculite free, vermiculite might be used to serve as a light weight filler. Specific concentrations, amounts, and identity of the optional vermiculite will be apparent to skilled practitioners who recognize that these parameters will vary depending on external preferences such as price and availability of the additional components and that the described embodiments do not limit the scope of the claimed invention.

The building material composition when used as a fire door core in accordance with the present invention is expected to provide several advantages over current fire resistant door cores, including but not limited to, increased production efficiency using methods known to those of ordinary skill, decreased raw material consumption, stronger adhesion to door shells, increased tensile and textural strength, superior hose stream resistance, decreased weight, and better shaping and handling characteristics. The phrase “consisting essentially of” when used in connection with the present invention and in the claims is intended to exclude not only the use of ingredients that would destroy the fire resistant property of the composition, but also to exclude the use of mineral dust and gypsum in amounts in excess of about 10% by weight and preferably in excess of about 1% by weight.

### Formulations

Non-limiting examples of the amounts of ingredients utilized in the practice of the present invention are shown below.

In one embodiment, the composition comprises an aqueous mixture, based on the total weight of the dry ingredients in the mixture, of:

(A) about 60.0% to about 93.0% of the cementitious composition in which about 20.0% to about 85.0% is cement, about 2.0% to about 10.0% is an accelerant, and about 4.0 to about 80.0% is a binder;

(B) up to about 4.5% of a dispersant;

(C) up to about 20% of unexpanded vermiculite;

(D) from about 0.01% to about 0.6% of a suspension agent;

(E) from about 1.0% to about 6.0% of fibrous reinforcements; and

(F) from about 0.1% to about 3.0% of an air entraining admixture.

In addition, the set material composition comprises from about 4.0% to about 23% of hollow microspheres.

In another embodiment, the aqueous mixture includes, based on the total weight of the dry ingredients in the mixture:

(A) from about 70.0% to about 90.0% of the cementitious composition in which about 30.0% to about 80.0% is cement, about 2.5% to about 9.0% is an accelerant, and at least about 2.5% of a refractory binder;

(B) at least about 1.5% of a dispersant;

(C) at least about 1.5% of fibrous reinforcements;

(D) from about 0.055 to about 0.4% of a suspension agent; and

(E) from about 0.2% to about 2.0% of an air entrainment admixture.

Further, the composition comprises from about 6.0% to about 20.0% of hollow microspheres.

In one embodiment, the composition comprises an aqueous mixture, based on the total weight of the dry ingredients in the mixture, of:

(A) about 60.0% to about 93.0% of the cementitious composition in which about 20.0% to about 85.0% is hydraulic cement, about 2.0% to about 10.0% is an accelerant, and about 4.0 to about 80.0% is a binder;

(B) up to about 4.5% of a dispersant;

(C) up to about 20% of unexpanded vermiculite;

(D) from about 0.01% to about 0.6% of a suspension agent;

(E) from about 1.0% to about 6.0% of fibrous reinforcements; and

(F) from about 0.1% to about 3.0% of an air entraining admixture.

In addition, the set material composition comprises from about 4.0% to about 23% of hollow microspheres.

In another embodiment, the aqueous mixture includes, based on the total weight of the dry ingredients in the mixture:

(A) from about 70.0% to about 90.0% of the cementitious composition in which about 30.0% to about 80.0% is hydraulic cement, about 2.5% to about 9.0% is an accelerant, and at least about 2.5% of a refractory binder;

(B) at least about 1.5% of a dispersant;

(C) at least about 1.5% of fibrous reinforcements;

(D) from about 0.055 to about 0.4% of a suspension agent; and

(E) from about 0.2% to about 2.0% of an air entrainment admixture.

Further, the composition comprises from about 6.0% to about 20.0% of hollow microspheres.

In one embodiment, the composition comprises an aqueous mixture, based on the total weight of the dry ingredients in the mixture, of:

(A) about 60.0% to about 93.0% of the cementitious composition in which about 20.0% to about 85.0% is refractory cement, about 2.0% to about 10.0% is an accelerant, and about 4.0 to about 80.0% is a binder;

(B) up to about 4.5% of a dispersant;

(C) up to about 20% of unexpanded vermiculite;

(D) from about 0.01% to about 0.6% of a suspension agent;

(E) from about 1.0% to about 6.0% of fibrous reinforcements; and

(F) from about 0.1% to about 3.0% of an air entraining admixture.

In addition, the set material composition comprises from about 4.0% to about 23% of hollow microspheres.

In another embodiment, the aqueous mixture includes, based on the total weight of the dry ingredients in the mixture:

(A) from about 70.0% to about 90.0% of the cementitious composition in which about 30.0% to about 80.0% is refractory cement, about 2.5% to about 9.0% is an accelerant, and at least about 2.5% of a refractory binder;

(B) at least about 1.5% of a dispersant;

(C) at least about 1.5% of fibrous reinforcements;

(D) from about 0.055 to about 0.4% of a suspension agent; and

(E) from about 0.2% to about 2.0% of an air entrainment admixture.

Further, the composition comprises from about 6.0% to about 20.0% of hollow microspheres.

In another embodiment, the composition comprises an aqueous mixture, based on the total weight of the dry ingredients in the mixture, of:

(A) about 60.0% to about 93.0% of the cementitious composition in which about 20.0% to about 85.0% is calcium aluminum cement, about 2.0% to about 10.0% is calcium sulfoaluminate cement, and about 4.0 to about 80.0% is fly ash;

(B) up to about 4.5% of SC-9;

(C) up to about 20% of unexpanded vermiculite;

(D) from about 0.01% to about 0.6% of a MS 510;

(E) from about 1.0% to about 6.0% of glass fiber 60-12 mm, 82tex (Owens Corning, Toledo, Ohio); and

(F) from about 0.1% to about 3.0% of MB AE-90.

In addition, the set material composition comprises from about 4.0% to about 23% of hollow glass microspheres.

In another embodiment, the aqueous mixture includes, based on the total weight of the dry ingredients in the mixture:

(A) from about 70.0% to about 90.0% of the cementitious composition in which about 30.0% to about 80.0% is calcium aluminum cement, about 2.5% to about 9.0% is calcium sulfoaluminate cement, and at least about 2.5% of fly ash;

(B) at least about 1.5% of SC-9;

(C) at least about 1.5% of glass fiber 60-12mm, 82tex;

(D) from about 0.055 to about 0.4% of MS 510; and

(E) from about 0.2% to about 2.0% of MB AE-90.

Further, the composition comprises from about 6.0% to about 20.0% of hollow glass microspheres.

In another embodiment, the composition comprises an aqueous mixture, based on the total weight of the dry ingredients in the mixture, of:

(A) about 60.0% to about 93.0% of the cementitious composition in which about 20.0% to about 85.0% is Portland cement, about 2.0% to about 10.0% is calcium chloride, and about 4.0 to about 80.0% is fly ash;

(B) up to about 4.5% of ACTI-GEL 208 admixture;

(C) up to about 20% of unexpanded vermiculite;

(D) from about 0.01% to about 0.6% of a MS 510;

(E) from about 1.0% to about 6.0% of glass fiber 60-12 mm, 82tex (Owens Corning, Toledo, Ohio); and

(F) from about 0.1% to about 3.0% of MB AE-90.

In addition, the set material composition comprises from about 4.0% to about 23% of hollow glass microspheres.

In another embodiment, the aqueous mixture includes, based on the total weight of the dry ingredients in the mixture:

(A) from about 70.0% to about 90.0% of the cementitious composition in which about 30.0% to about 80.0% is Portland cement, about 2.5% to about 9.0% is calcium chloride, and at least about 2.5% of fly ash;

(B) at least about 1.5% of ACTI-GEL 208 admixture;

(C) at least about 1.5% of glass fiber 60-12mm, 82tex;

(D) from about 0.055 to about 0.4% of MS 510; and

(E) from about 0.2% to about 2.0% of MB AE-90.

Further, the composition comprises from about 6.0% to about 20.0% of hollow glass microspheres.

In another embodiment, the composition comprises an aqueous mixture, based on the total weight of the dry ingredients in the mixture, of:

(A) about 60.0% to about 93.0% of the cementitious composition in which about 20.0% to about 85.0% is gypsum cement, about 2.0% to about 10.0% is potash, and about 4.0 to about 80.0% is fly ash;

(B) up to about 4.5% of SC-9;

(C) up to about 20% of unexpanded vermiculite;

(D) from about 0.01% to about 0.6% of a MS 510;

(E) from about 1.0% to about 6.0% of glass fiber 60-12 mm, 82tex (Owens Corning, Toledo, Ohio); and

(F) from about 0.1% to about 3.0% of MB AE-90.

In addition, the set material composition comprises from about 4.0% to about 23% of hollow glass microspheres.

In another embodiment, the aqueous mixture includes, based on the total weight of the dry ingredients in the mixture:

(A) from about 70.0% to about 90.0% of the cementitious composition in which about 30.0% to about 80.0% is gypsum cement, about 2.5% to about 9.0% is potash, and at least about 2.5% of fly ash;

(B) at least about 1.5% of SC-9;

(C) at least about 1.5% of glass fiber 60-12mm, 82tex;

(D) from about 0.055 to about 0.4% of MS 510; and

(E) from about 0.2% to about 2.0% of MB AE-90.

Further, the composition comprises from about 6.0% to about 20.0% of hollow glass microspheres.

### Manufacturing Methods

The building material composition, e.g., fire door core, of the present invention is manufactured by combining the dry components with water to form a slurry, e.g., a wet door core mixture according to following steps: (1) the water for mixing is prepared and poured to the mixer; (2) the binder such is added to the mixer; (3) the hydraulic cement with cement admixtures, if present, such as dispersant or a suspension agent or a air entrainment agent is added to the mixer; (4) an accelerant is added next, followed by (5) fibrous reinforcements, if present, and (6) hollow beads.

In another embodiment, all dry ingredients except the accelerant (e.g. hydraulic cement, binder, optional ingredients (e.g. dispersant, suspension agent, fibrous reinforcement, etc.)) if present are combined in a mixer. Water and, if present, the air entrainment admixture is added to the mixer to make a slurry. The hollow beads and, if present, an accelerant is added to the slurry to make the final wet door core mixture.

In another embodiment, all dry ingredients (e.g. hydraulic cement, accelerant, binder, optional ingredients (e.g. dispersant, suspension agent, fibrous reinforcement, etc.)) if present are combined in a mixer. Water and, if present, air entrainment admixture is added to the mixer to make a slurry. The hollow beads are then added to the slurry to make the final wet door core mixture.

In another embodiment, hollow beads, air entrainment admixture, and all dry ingredients (e.g. hydraulic cement, accelerant, binder, optional ingredients (e.g. dispersant, suspension agent, fibrous reinforcement, etc.)) if present are combined in a mixer. Water is added to the mixer to make a slurry.

The amount of water to use in making a set door core is at least sufficient to provide the stoichiometric amount of water needed to cause the setting (curing) of the cementitious composition. It is generally desirable to include an amount of water in excess of the stoichiometric amount. In certain embodiments, it may be preferred to use only an amount of water sufficient to provide a damp (moist) mixture of the ingredients.

In alternative embodiments, higher amounts of water can be used, for example, amounts that produce a slurry of the dry, solid ingredients. In most cases, a set door core can be prepared readily using from about 18% to about 29% or from about 22% to about 28% or from about 24% to about 27% by weight of water based on the weight of the dry ingredients comprising the mixture.

The wet mixture, e.g., the wet door core mixture, then is poured into a preformed mold, vibrated or tamped for uniform dispersion of the mix in the mold e.g., a wet door core. The wet composite, e.g., wet door core, then is cured to form the building material composition, e.g., the fire door core, of the invention.

As described herein, the wet mixture, e.g., the wet door core mixture, and the wet composite, e.g., wet door core, preferably have a solids concentrations, and resultant viscosities, that provide ease of handling, i.e., the solids concentrations are not so high as to be difficult to mix or transfer from mixer to the mold, and is not so low as to yield a wet composite, e.g., a wet door core, that lacks dimensional stability. Therefore, the form, i.e., whether a solid or an aqueous solution, of an individual component used in preparing the mixture from which the building material composition is prepared, typically is selected so that the solids concentration of the wet mixture, e.g., the wet door core mixture and the wet composite, e.g., the wet door core, need not be adjusted. However, additional water may be added to obtain a wet mixture, e.g., a wet door core mixture and then a wet composite, e.g., a wet door core, having a desired viscosity, if necessary.

The continuous roll press method is a known process of making fire door cores. Illustrative of the known roll method is the method described in U.S. Pat. No. 5,256,222, which is incorporated in its entirety herein. A non-solid mixture of the components of the fire door core is deposited onto a moving web drawn from a supply roll by pull rolls. Then, another moving web drawn from its own supply roll by pull rolls is directed by guide and press roll onto the top of the mixture. The thickness of the sandwich of fire door core mixture and webbing then is reduced to a desired value. The roll molded fire door core then is transported by known industrial methods to a drying area. The drying of the roll molded fire door core can be achieved at ambient temperature or by using drying equipment that operates at a temperature greater than room temperature.

The ingredients of the building material composition, e.g., the fire door core, are mixed in a mixing device that is well known to skilled practitioners. Preferably, the dry ingredients are mixed with an amount of water no greater than that required to provide a damp (moist) mixture of the ingredients and then molding the damp mixture to form the core as described below. Often the ingredients of the composition, e.g., the fire door core ingredients, are mixed in a manner to keep the powder from clumping. The glass fiber should be added with suitable speed, thus preventing undesirable clustering. When AE-90 is added directly to the mixer, a careful observation is required to make sure that the mixer is blending all constituents in a uniform manner. When poured to the mold, the material may be uniformly dispersed throughout the mold by utilization of additional vibrations. The purpose of vibration is leveling and uniformly consolidating of the door core mix once in the form. Vibration apparatus should be installed on the production line so that once the door core wet mix has been poured into the mold with sufficient quantity of door core wet mix to fill the mold, vibration apparatus will insure mix consolidation as well as leveling. Depending on size and weight of filled mold (including weight of mold) sufficient amplitude and frequency of vibration is applied uniformly to the entire mold in order to insure that door core wet mix is level and uniformly dispersed in the mold. Vibration apparatus and tuning to perform this step is known to those skilled in the art. Once set, the molded core may be taken out of the mold and placed in an oven at 160 degrees F. for approximately 72 hours to accelerate final cure and eliminate excess water from the final building material composition.

In order to effectuate the best use of hollow beads during mixing, often the other components of the composition, e.g., the other fire door core ingredients, are mixed together first. Accordingly in some embodiments of the present invention, a Class C fly ash is added first to the mixer, said mixer having stoichiometric amount of water needed to cause the setting (curing) of the cementitious composition. Then, calcium aluminate cement with an already pre-blended SC-9 are added to the mixer, followed by an accelerant such as calcium sulfoaluminate cement and suitable fiber glass. This allows hollow beads (added last) to thoroughly blend with the other ingredients.

The wet mixture, e.g., the wet door core mixture then is transferred to a mold having a shape corresponding to desired composite dimensions. The transfer step can be accomplished using any of the techniques well known to skilled practitioners. The wet mixture, e. g., the wet door core mixture then is compression molded to compact the mixture to the desired density and thickness to produce a wet composite, e.g., a wet door core.

The wet composite, e.g., wet door core, then is dried (cured) to produce the building material composition, e.g., the fire door core of the present invention. The wet composite, e.g., the wet door core is cured (i.e., dried) at a temperature and for a time sufficient to substantially eliminate excess water from the wet composite, e.g., from the wet door core. The drying can be accomplished at ambient temperature or at elevated temperatures such as from about 150° to about 300° Fahrenheit (about 65° C. to 150° C.). Alternatively, the drying can occur in two or more stages using two or more temperatures. For example, the initial drying can occur in ambient temperature followed by elevated temperatures or vice versa. The drying (curing) time will depend on the composition of the composition, temperature, thickness of the molded wet door core can range from a day to a week or longer. Suitable temperature and time schedules can be determined using routine testing.

After the core has been dried, finishing operations can be effected. For example, the core can be sanded to a thickness within the required tolerance, sawed or shaped as desired. The nature of the dried material is such that finishing operations can be performed readily.

During the course of finishing operations such as sanding and sawing, core dust is produced. In accordance with this invention, it is anticipated that the dust can be used in preparing other cores by including it in the mixture from which the core is made. This is advantageous because it makes use of a material that would otherwise be waste requiring disposal. The use of core dust is expected to increase the density of the core. Accordingly, the maximum amount of core dust used will be governed by the desired density of the core. It is recommended that the core dust comprise no more than about 8% of the total weight of the dry mixture of ingredients. Alternatively, the core dust should comprise no more that about 1% to about 5% of the total weight of the dry mixture.

### EXAMPLES

The following examples are illustrative of the present invention and parts and percentages are by dry weight unless otherwise indicated. It should be noted that these examples are only that—examples—a wide range of conditions, which together with the above descriptions, illustrate the invention in a non limiting fashion.

For each of the examples listed below, water in an amount of about 10% to about 45% or from about 15% to about 35% or from about 20% to about 30% by weight of the dry ingredients should be added. The foam aggregate can be made separate and then added to the mixture of dry ingredients with or without water. Alternatively, the foam concentrate can be added to the mixture of dry ingredients with or without water and the foam aggregate produced in situ. The wet door core mixture (i.e. foam aggregate plus cementitious composition plus water) can be dried (cured) using ambient or elevated temperatures such as from about 160° F. to about 170° F. (71° C.-77° C.). Alternatively, the wet door core mixture can be initially dried (cured) using ambient temperatures and finished using elevated temperatures. Alternatively, the wet door core mixture can be initially dried (cured) using elevated temperatures and finished using ambient temperatures.

### Example 1

A door core of the present invention of the following composition can be manufactured from a mixture of the following ingredients:

| | | Amount (dry |
|---|---|---|
| Ingredients | Weight (lb) | weight percent) |
| DRY | | |
| Calcium aluminate | 813.0 | 46.7 |
| cement | | |
| Fly Ash | 476.0 | 27.3 |
| Calcium | 123.0 | 7.1 |
| sulfonaluminate | | |
| cement | | |
| Glass Beads | 215.0 | 12.4 |
| Glass Fiber | 60.0 | 3.4 |
| MS 510 | 3.0 | 0.2 |
| SC-9 | 50.8 | 2.9 |
| Total | 1,740.80 lb | 100.0% |
| WET | | |
| Water | 396 | 22.7 |
| MB AE-90 | 8.0 | 0.46 |
| (Solution) | | |

### Example 2

A door core of the present invention of the following composition can be manufactured from a mixture of the following ingredients:

| | | Amount (dry |
|---|---|---|
| Ingredients | Weight (lb) | weight percent) |
| DRY | | |
| Calcium aluminate | 813.0 | 47.6 |
| cement | | |
| Fly Ash | 476.0 | 27.7 |
| Calcium | 60.0 | 3.5 |
| sulfoaluminate | | |
| cement | | |
| Glass Beads | 250.0 | 14.6 |
| Glass Fiber | 60.0 | 3.5 |
| MS 510 | 3.0 | 0.2 |
| SC-9 | 51.26 | 2.9 |
| Total | 1,713.26 lb | 100.0% |
| WET | | |
| Water | 414.0 | 24.2 |

### Example 3

A door core of the present invention of the following composition can be manufactured from a mixture of the following ingredients:

| | | Amount (dry |
|---|---|---|
| Ingredients | Weight (lb) | weight percent) |
| DRY | | |
| Portland cement | 813.0 | 46.7 |
| Fly Ash | 476.0 | 27.3 |
| Calcium chloride | 123.0 | 7.1 |
| Glass Beads | 215.0 | 12.4 |
| Glass Fiber | 60.0 | 3.4 |
| MS 510 | 3.0 | 0.2 |
| ACTI-GEL 208 | 50.8 | 2.9 |
| admixture | | |
| Total | 1,740.80 lb | 100.0% |
| WET | | |
| Water | 396 | 22.7 |
| MB AE-90 | 8.0 | 0.46 |

### Example 4

A door core of the present invention of the following composition can be manufactured from a mixture of the following ingredients:

| | | Amount (dry |
|---|---|---|
| Ingredients | Weight (lb) | weight percent) |
| DRY | | |
| Portland cement | 813.0 | 47.6 |
| Fly Ash | 476.0 | 27.7 |
| Calcium chloride | 60.0 | 3.5 |
| Glass Beads | 250.0 | 14.6 |
| Glass Fiber | 60.0 | 3.5 |
| MS 510 | 3.0 | 0.2 |
| ACTI-GEL 208 | 51.26 | 2.9 |
| admixture | | |
| Total | 1,713.26 lb | 100.0% |
| WET | | |
| Water | 414.0 | 24.2 |

### Example 5

A door core of the present invention of the following composition can be manufactured from a mixture of the following ingredients:

| | | Amount (dry |
|---|---|---|
| Ingredients | Weight (lb) | weight percent) |
| DRY | | |
| Gypsum cement | 813.0 | 46.7 |
| Fly Ash | 476.0 | 27.3 |
| Potash | 123.0 | 7.1 |
| Glass Beads | 215.0 | 12.4 |
| Glass Fiber | 60.0 | 3.4 |
| MS 510 | 3.0 | 0.2 |
| SC-9 | 50.8 | 2.9 |
| Total | 1,740.80 lb | 100.0% |
| WET | | |
| Water | 396 | 22.7 |
| MB AE-90 | 8.0 | 0.46 |

### Example 6

A door core of the present invention of the following composition can be manufactured from a mixture of the following ingredients:

| | | Amount (dry |
|---|---|---|
| Ingredients | Weight (lb) | weight percent) |
| DRY | | |
| Gypsum cement | 813.0 | 47.6 |
| Fly Ash | 476.0 | 27.7 |
| Potash | 60.0 | 3.5 |
| Glass Beads | 250.0 | 14.6 |
| Glass Fiber | 60.0 | 3.5 |
| MS 510 | 3.0 | 0.2 |
| SC-9 | 51.26 | 2.9 |
| Total | 1,713.26 lb | 100.0% |
| WET | | |
| Water | 414.0 | 24.2 |

Although the invention has been described with reference to specific embodiments, this description is not meant to be construed in a limited sense. Various modifications of the disclosed embodiments, as well as alternative embodiments of the invention will become apparent to persons skilled in the art upon the reference to the description of the invention. It is, therefore, contemplated that the appended claims will cover modifications that fall within the scope of the invention. Unless otherwise specifically indicated, all percentages are by weight throughout the specification and in the claims.

What is claimed is:

1. A composition useful for producing a fire door core comprising a mixture of:
(a) a hollow microsphere and
(b) a cementitious composition comprising at least one of the following:
(i) a hydraulic cement,
(ii) an accelerant, or
(iii) a binder;
wherein the composition can be molded or shaped into a fire door core.

2. The composition of claim 1, wherein the hollow microspheres are selected from the group consisting of: glass, ceramic, metals, plastic, and composites.

3. The composition of claim 1, wherein the cementitious composition includes the hydraulic cement, and the hydraulic cement is selected from the group consisting of: refractory cement, calcium aluminate cement, CIMENT FONDU cement, Portland cement, magnesium based cement, gypsum cement, cements with a mixture of silicates, oxides, perlite, clay, bentonite clay, or fire clay, and combinations thereof.

4. The composition of claim 1, wherein the cementitious composition includes the accelerant, and the accelerant is selected from the group consisting of: alkali metal halides, alkali metal nitrites, alkali metal nitrates, alkali metal formates, alkali metal thiocyanates, calcium chloride, non-calcium chloride, calcium carbonate, calcium hydroxide, triethanol amine, sodium thiocyanate, sodium nitrate, calcium formate, calcium nitrate, calcium nitrite, lithium hydroxide monohydrate, lithium sulfate monohydrate, lithium carbonate, potash, calcium sulfoaluminate cement, and RAPID SET cement

5. The composition of claim 1, wherein the cementitious composition includes the binder, and the binder is selected from the group consisting of: type C fly ash, type F fly ash, pozzolanic materials, slag, silica fume, metakaolin, aluminosilicate powders, calcium sulfate, magnesium phosphate, lime, magnesium oxides, geopolymers, and gypsum, starches, dextins gums, polyvinyl alcohol, polyvinyl acetate, polymers of vinyl acetate and ethylene, polymers of styrene and butadiene, acrylic resins, and rice hulls.

6. The composition of claim 1, further comprising one or more of the following:
(a) a dispersant;
(b) a suspension agent;
(c) a fibrous reinforcement;
(d) an air entrainment agent; or
(e) diatomaceous earth.

7. The composition of claim 6, wherein the composition includes the dispersant, and the dispersant is selected from the group consisting of: water soluble polymers, superplasticizers, sodium pentahydyoxycaproate based, polycarboxylate based, melamine sulfonic acid based, naphthalenesuflonic acid based, lingosulfonate based, and SC-9.

8. The composition of claim 6, wherein the composition includes the suspension agent, and the suspension agent is selected from the group consisting of: bentonite based, cellulose based, gum based, lingosulfonate based, polyvinyl alcohol based, polyvinylpyrrolidone based, MS510, and palygorskite based.

9. The composition of claim 6, wherein the composition includes the fibrous reinforcement, and the fibrous reinforcement is selected from the group consisting of: glass fibers, steel fibers, sisal fibers, graphite, synthetic fibers, polyolefin fibers, polyethylene fibers, polypropylene fibers, rayon fibers, and polyacrylonitrile fibers.

10. The composition of claim 6, wherein the composition includes the air entrainment agent, and the air entrainment agent is selected from the group consisting of: wood resins, animal or vegetable fats, wetting agents, water soluble soaps of certain acids, Eucon air entraining admixtures, DAREX air entraining admixture, AIRALOM 3000, DARAVAIR, TERAPAVE AEA, Air Plus, MB AE-90, TOUGH AIR admixture, MasterAir, MasterCell, CreteFoam CMX, Sika, Air 260, Con Air, RSA-10, RVR-15, and Lightcrete Powder.

11. The composition of claim 1, wherein the hollow microspheres are present in an amount from about 4% to about 23% of a dry weight of the composition.

12. The composition of claim 1, wherein the cementitious composition includes the hydraulic cement in an amount from about 20% to about 85% of a dry weight of the composition.

13. The composition of claim 1, wherein the cementitious composition includes the accelerant in an amount from about 2% to about 10% of a dry weight of the composition.

14. The composition of claim 1, wherein the cementitious composition includes the binder in an amount from about 4% to about 80% of a dry weight of the composition.

15. A composition useful as a fire door core comprising a mixture of:
(a) a hollow microsphere selected from the group consisting of: glass, ceramic, metals, plastic, and composites; and
(b) a cementitious composition comprising:
(i) a hydraulic cement selected from the group consisting of: refractory cement, calcium aluminate cement, CIMENT FONDU cement, Portland cement, magnesium based cement, gypsum cement, cements with a mixture of silicates, oxides, perlite, clay, bentonite clay, or fire clay, and combinations thereof;
(ii) an accelerant selected from the group consisting of: alkali metal halides, alkali metal nitrites, alkali metal nitrates, alkali metal formates, alkali metal thiocyanates, calcium chloride, non-calcium chloride, calcium carbonate, calcium hydroxide, triethanol amine, sodium thiocyanate, sodium nitrate, calcium formate, calcium nitrate, calcium nitrite, lithium hydroxide monohydrate, lithium sulfate monohydrate, lithium carbonate, potash, calcium sulfoaluminate cement, and RAPID SET cement; and
(iii) a binder selected from the group consisting of: fly ash, pozzolanic materials, slag, silica fume, metakaolin, aluminosilicate powders, calcium sulfate, magnesium phosphate, lime, magnesium oxides, geopolymers, and gypsum, starches, dextins gums, polyvinyl alcohol, polyvinyl acetate, polymers of vinyl acetate and ethylene, polymers of styrene and butadiene, acrylic resins, and rice hulls;
wherein the composition can be molded or shaped into a fire door core.

16. The composition of claim 15, further comprising at least one of the following:
(a) a dispersant selected from the group consisting of: water soluble polymers, superplasticizers, sodium pentahydyoxycaproate based, polycarboxylate based, melamine sulfonic acid based, naphthalenesuflonic acid based, lingosulfonate based, and SC-9;
(b) a suspension agent selected from the group consisting of: bentonite based, cellulose based, gum based, lingosulfonate based, MS510, and palygorskite based;
(c) a fibrous reinforcement selected from the group consisting of: glass fibers, steel fibers, sisal fibers, graphite, and synthetic fibers such as, for example, polyolefin fibers, such as polyethylene fibers and polypropylene fibers, rayon fiber and polyacrylonitrile fiber;
(d) an air entrainment agent selected from the group consisting of: wood resins, animal or vegetable fats, wetting agents, water soluble soaps of certain acids, Eucon air entraining admixtures, DAREX air entraining admixture, AIRALOM 3000, DARAVAIR, TERAPAVE AEA, Air Plus, MB AE-90, TOUGH AIR admixture, MasterAir, MasterCell, CreteFoam CMX, Sika, Air 260, Con Air, RSA-10, RVR-15, and Lightcrete Powder; or
(e) diatomaceous earth.

17. A method for making a fire door core comprising the steps of:
(a) combining a hollow microsphere, a cementitious composition, and water to produce a slurry;
(b) pouring the slurry into a mold; and
(c) curing the molded slurry;
wherein the cementitious composition comprises at least one of the following: a hydraulic cement, an accelerant, or a binder.

18. The method of claim 17, wherein the hollow microspheres are selected from the group consisting of: glass, ceramic, metals, plastic, and composites

19. The method of claim 17, wherein the cementitious composition includes the hydraulic cement, the accelerant, and the binder;
wherein the hydraulic cement is selected from the group consisting of: refractory cement, calcium aluminate cement, CIMENT FONDU cement, Portland cement, magnesium based cement, gypsum cement, cements with a mixture of silicates, oxides, perlite, clay, bentonite clay, or fire clay, and combinations thereof
wherein the accelerant is selected from the group consisting of: alkali metal halides, alkali metal nitrites, alkali metal nitrates, alkali metal formates, alkali metal thiocyanates, calcium chloride, non-calcium chloride, calcium carbonate, calcium hydroxide, triethanol amine, sodium thiocyanate, sodium nitrate, calcium formate, calcium nitrate, calcium nitrite, lithium hydroxide monohydrate, lithium sulfate monohydrate, lithium carbonate, potash, calcium sulfoaluminate cement, and RAPID SET cement; and
wherein the binder is selected from the group consisting of: fly ash, pozzolanic materials, slag, silica fume, metakaolin, aluminosilicate powders, calcium sulfate, magnesium phosphate, lime, magnesium oxides, geopolymers, and gypsum, starches, dextins gums, polyvinyl alcohol, polyvinyl acetate, polymers of vinyl acetate and ethylene, polymers of styrene and butadiene, acrylic resins, and rice hulls.

20. The method of claim 17, wherein step 1 further includes at least one of the following:
(a) a dispersant selected from the group consisting of: water soluble polymers, superplasticizers, sodium pentahydyoxycaproate based, polycarboxylate based, melamine sulfonic acid based, naphthalenesuflonic acid based, lingosulfonate based, and SC-9;
(b) a suspension agent selected from the group consisting of: bentonite based, cellulose based, gum based, lingosulfonate based, MS510, and palygorskite based;
(c) a fibrous reinforcement selected from the group consisting of: glass fibers, steel fibers, sisal fibers, graphite, and synthetic fibers such as, for example, polyolefin fibers, such as polyethylene fibers and polypropylene fibers, rayon fiber and polyacrylonitrile fiber;
(d) an air entrainment agent selected from the group consisting of: wood resins, animal or vegetable fats, wetting agents, water soluble soaps of certain acids, Eucon air entraining admixtures, DAREX air entraining admixture, AIRALOM 3000, DARAVAIR, TERAPAVE AEA, Air Plus, MB AE-90, TOUGH AIR admixture, MasterAir, MasterCell, CreteFoam CMX, Sika, Air 260, Con Air, RSA-10, RVR-15, and Lightcrete Powder; or
(e) diatomaceous earth.
